(19) United States
(12) Patent Application Publication
(10) Pub. No.: US 2018/0184422 A1
(43) Pub. Date: Jun. 28, 2018

(54) MULTI-CHANNEL TIME SYNCHRONIZED MESH NETWORKING

(71) Applicant: Intel Corporation, Santa Clara, CA (US)

(72) Inventors: Dave Cavalcanti, Beaverton, OR (US); Chittabrata Ghosh, Freemont, CA (US)

(21) Appl. No.: 15/392,753

(22) Filed: Dec. 28, 2016

(51) Int. Cl. H04W 72/04; H04B 7/14; H04L 12/26

(52) U.S. Cl. CPC H04W 72/0446; H04W 84/18; H04L 43/16; H04B 7/14

(57) ABSTRACT

This disclosure describes systems, methods, and apparatus related to narrowband mesh networking. A device may determine one or more first devices within a coverage area of the device. The device may encode a timeslot frame (TSF) for transmission on a first narrowband channel of one or more narrowband channels. The device may cause the TSF to be wirelessly transmitted to the one or more devices over the first narrowband channel.

### TECHNICAL FIELD

This disclosure generally relates to systems, methods, and devices for wireless communications and, more particularly, multi-channel time synchronized mesh networking.

### BACKGROUND

Wireless devices are becoming widely prevalent and are increasingly requesting access to wireless channels. Internet of Things (IoT) devices may require preservation of power in order to operate for extended periods of time while still being able to access the Internet. IoT devices are devices that may be addressable and controllable through one or more communications network.

### BRIEF DESCRIPTION OF THE DRAWINGS

FIG. 1 depicts a diagram illustrating an example network environment for an illustrative narrowband mesh networking system, in accordance with one or more example embodiments of the present disclosure.

FIG. 2 depicts an illustrative narrowband channel allocation, in accordance with one or more example embodiments of the present disclosure.

FIG. 3 depicts an illustrative mesh network, in accordance with one or more example embodiments of the present disclosure.

FIG. 4 depicts an illustrative narrowband service channel timeslot frame (TSF) structure, in accordance with one or more example embodiments of the present disclosure.

FIG. 5 depicts a narrowband service channel TSF, in accordance with one or more example embodiments of the present disclosure.

FIG. 6A depicts an illustrative narrowband mesh networking system, in accordance with one or more example embodiments of the present disclosure.

FIG. 6B depicts an illustrative example of a narrowband service channel TSF, in accordance with one or more example embodiments of the present disclosure.

FIG. 7A illustrates a flow diagram of illustrative for an illustrative narrowband mesh networking system, in accordance with one or more example embodiments of the present disclosure.

FIG. 7B depicts a flow diagram of an illustrative process for an illustrative narrowband mesh networking system, in accordance with one or more example embodiments of the present disclosure.

FIG. 8 illustrates a functional diagram of an example communication station that may be suitable for use as a user device, in accordance with one or more example embodiments of the present disclosure.

FIG. 9 illustrates a block diagram of an example machine upon which any of one or more techniques (e.g., methods) may be performed, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Next generation 3GPP 5G and Wi-Fi networks is expected to focus on better user experiences under high dense scenarios, as well as enable connectivity for large numbers of IoT devices, which are typically resource and power constrained. Many large scale IOT systems, such as smart grid/buildings/cities, industrial automation, require flexible and scalable mesh network architectures. In many cases, devices may be outside the coverage of an access point (AP) due to power restrictions, extended area/sparse deployment or other constraints. It is desirable to enable a more efficient support for mesh networking and resource constrained/low power devices within next generation/5G Wi-Fi networks.

Example embodiments of the present disclosure relate to systems, methods, and devices for enabling support for mesh networking and resource constrained and low power devices within next generation/5G Wi-Fi networks.

In one embodiment, a narrowband mesh networking system may enable a more flexible and scalable mesh operation, which is required for supporting many IOT applications and systems.

In one embodiment, a narrowband mesh networking system may enable the usage of narrowband Wi-Fi sub-channels within a single wide band channel in a mesh topology in a time synchronized fashion, which allows for low power operation and better coexistence with typical Wi-Fi traffic.

In one embodiment, a narrowband mesh networking system may enable an access point (AP) to act as a coordinator device that may define a time slot frame structure, may provide time synchronization, and may acquire and/or announce available resources across multiple narrowband sub-channels and time slots to one or more devices within the coverage area of the AP.

In one embodiment, a narrowband mesh networking system may enable a more flexible and scalable operation between one or more devices, which is required for supporting many IoT applications and systems. IoT devices may require optimized power usage and may not need a large bandwidth for their communications.

The above descriptions are for purposes of illustration and are not meant to be limiting. Numerous other examples, configurations, processes, etc., may exist, some of which are described in detail below. Example embodiments will now be described with reference to the accompanying figures.

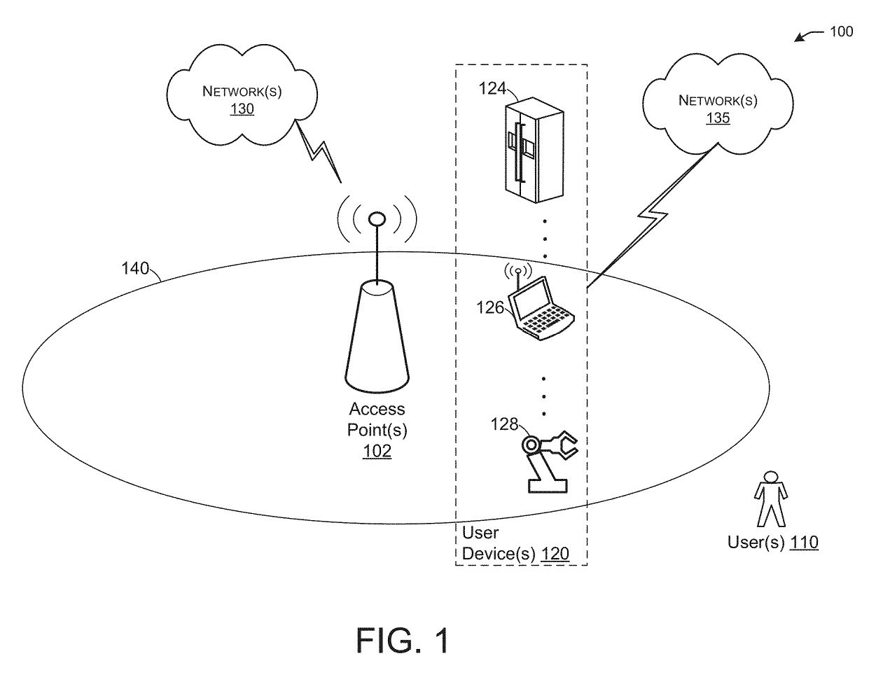

FIG. 1 is a diagram illustrating an example network environment, in accordance with one or more example embodiments of the present disclosure. Wireless network 100 may include one or more user devices 120 and one or more access point(s) (AP) 102, which may communicate in accordance with and compliant with various communication standards and protocols, such as, Wi-Fi, TSN, Wireless USB, P2P, Bluetooth, NFC, or any other communication standard. The user device(s) 120 may be mobile devices that are non-stationary (e.g., not having fixed locations) or may be stationary devices.

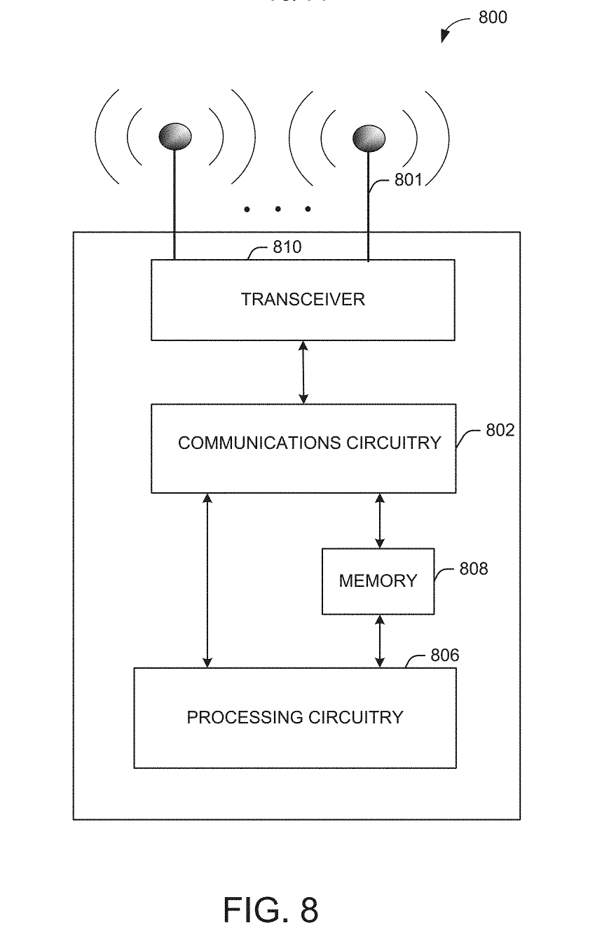

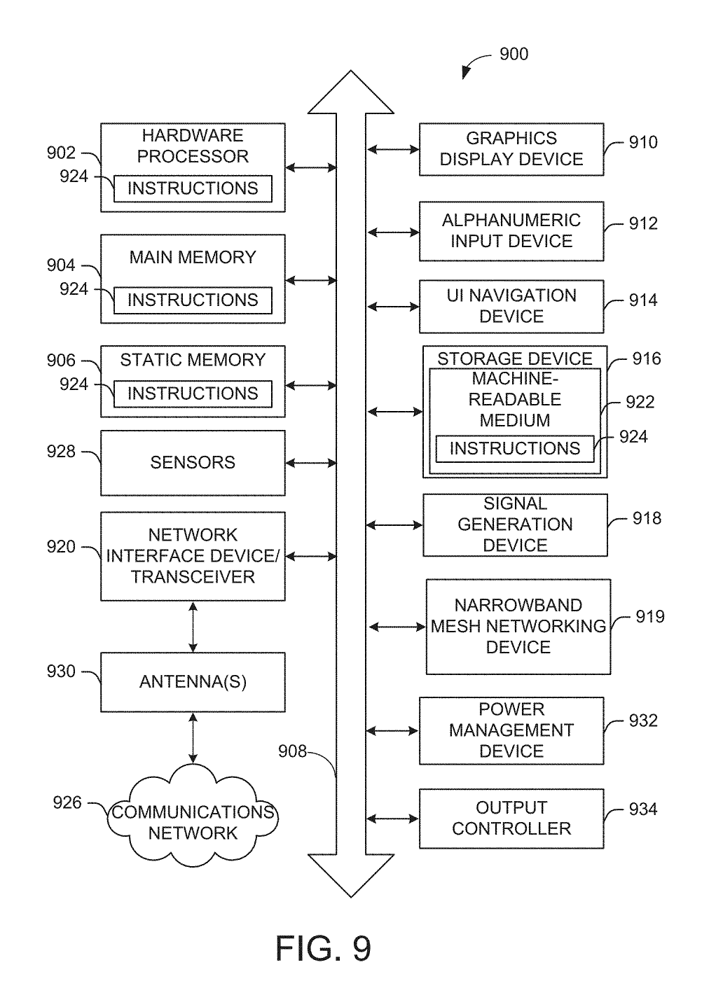

In some embodiments, the user devices 120 and AP 102 may include one or more computer systems similar to that of the functional diagram of FIG. 8 and/or the example machine/system of FIG. 9.

One or more illustrative user device(s) 120 and/or AP 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP 102 may operate as a personal basic service set (PBSS) control point/access point (PCP/AP). The user device(s) 120 (e.g., 124, 126, or 128) and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a robotic device, an actuator, a robotic arm, an industrial robotic device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP 102 may also include mesh stations in, for example, a mesh network, in accordance with one or more IEEE 802.11 standards and/or 3GPP standard.

Any of the user device(s) 120 (e.g., user devices 124, 126, 128), and AP 102 may be configured to communicate with each other via one or more communications networks 130 and/or 135 wirelessly or wired. The user device(s) 120 may also communicate peer-to-peer or directly with each other with or without the AP 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP 102 may include one or more communications antennas. The one or more communications antennas may be any suitable type of antennas corresponding to the communications protocols used by the user device(s) 120 (e.g., user devices 124, 126 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP 102.

Any of the user device(s) 120 (e.g., user devices 124, 126, 128), and AP 102 may be configured to perform directional transmission and/or directional reception in conjunction with wirelessly communicating in a wireless network. Any of the user device(s) 120 (e.g., user devices 124, 126, 128), and AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP 102 may be configured to perform any given directional transmission towards one or more defined transmit sectors. Any of the user device(s) 120 (e.g., user devices 124, 126, 128), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more communication standards and protocols, such as, Wi-Fi, TSN, Wireless USB, Wi-Fi P2P, Bluetooth, NFC, or any other communication standard. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

When an AP (e.g., AP 102) establishes communication with one or more user devices 120 (e.g., user devices 124, 126, and/or 128), the AP 102 may communicate in a downlink direction and the user devices 120 may communicate with the AP 102 in an uplink direction by sending frames in either direction. The user devices 120 may also communicate peer-to-peer or directly with each other with or without the AP 102.

Typically, a device may scan its neighboring devices in order to find an AP. If the device could not find an AP, the device may not be able to access the network (e.g., the Internet). Either the device may have to be moved to be closer to an AP or additional APs may have to be added such that the device is able to access the network through a proximate AP.

In one embodiment, and with reference to FIG. 1, the AP 102 may be associated with a coverage area 140, which determines the range of the APs reach such that devices within that coverage area 140 may be able to receive and/or send packets to and from the AP 102. For example, user devices 126 and 128 are shown to be within the coverage area 140 and hence are capable of receiving and sending packets. However, user device 124 is outside the coverage area 140 and hence may be unable to hear the AP 102. A narrowband mesh networking system may enable one of the devices within the coverage area 142 act as a relay device such that user device 124 will the able to receive messages from the AP 102 through the relay device. For example, user device 124 may be in proximity to user device 126. The user device 126 may act as a relay device such that the user device 126 may relay messages between the user device 124 and the AP 102. It should be understood that when a device is outside the coverage area may also cover cases when the device 124 may communicate with the AP 102 but at a lower rate or with a lower performance (e.g. higher packet error rate). For example, if power measurement or link quality falls below a threshold, a device may not reliably communicate with the AP 102. In those cases, the user device 126 acting as a relay device may allow the user device 124 to have a more enhanced communication with the AP 102. Hence, there is value in using the relay device even in cases where a certain device is within coverage of the AP, but may have poor link quality.

In one embodiment, the narrowband mesh networking system may divide a frequency band into one or more narrowband channels that may be utilized by the AP 102 and the user device 120 in to implement a mesh network. For example, a single wide band frequency channel of 20 MHz may be divided into a number of narrowband subchannels. The AP 102 and the user devices 120 may utilize these narrowband subchannels in order to communicate in a synchronized fashion. It is understood that the above descriptions are for purposes of illustration and are not meant to be limiting.

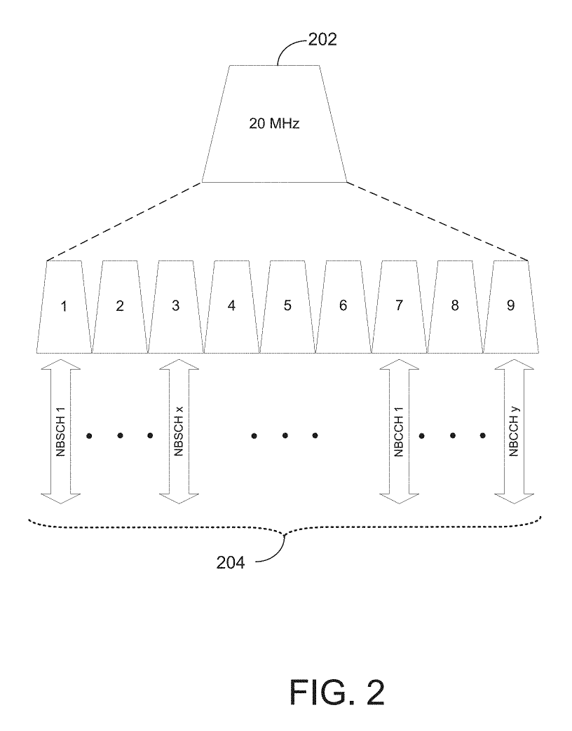

FIG. 2 depicts an illustrative narrowband channel allocation, in accordance with one or more example embodiments of the present disclosure.

Referring to FIG. 2, there is shown a single wide band frequency channel of 20 MHz (e.g., channel 202). A narrowband mesh networking system may facilitate dividing the channel 202 into multiple narrowband subchannels (e.g., channels 204) that may be dedicated for certain functions. For example, the channel 202 may be divided into a number narrowband channels e.g., 9 narrowband channels). The narrowband channels may be dedicated channels. For example, narrowband channels 204 may be comprised of one or more narrowband service channels (NBSCH) (e.g., NBSCH 1 . . . x, where x is an integer) and one or more narrowband control channels (NBCCH) (e.g., NBCCH1 . . . y, where y is an integer). This may enable a narrowband device that can operate in smaller frequencies to operate with other narrowband devices and may benefit from the smaller frequency allocations. The NBSCH may be used for data traffic, while the NBCCH may be used for control and management traffic.

In one embodiment, an AP may use the control channel to send and receive control traffic to one or more devices that may be associated and/or belong to that AP. The assumption is that each device is able to hear the AP and get the control traffic from the AP and able to send and receive data using these smaller frequency allocations. In order to operate in this mode, a device will need to listen to the control channel and use the data channels to transmit its data traffic. Smaller devices, such as IoT devices, may have power constraints and may not always be within the range of an AP.

In one embodiment, a narrowband mesh networking system may enable a device that may be outside the coverage area of the AP to detect and/or receive control traffic from the AP, through one or more relay devices. In one embodiment, a narrowband mesh networking system may enable multi-channel time synchronization in order to preserve power of one or more devices. Under this, the one or more devices may preserve power by having a prearranged time schedule to wake up and to send their data.

It should be understood that although channel 202 is shown to be 20 MHz, and is divided into nine, 2 MHz narrowband channels other wideband channels may be utilized. For example, within a wideband channel of 160 MHz, there may be 8*20 MHz narrowband channels, etc. also, it should be noted that one or more narrowband channels may be combined together in order to generate an aggregated narrowband channel. The number of NBSCH and NBCCH may be determined by the system, by the AP, or by system administrator preference.

Typically, there is no support for devices to operate in a Wi-Fi network, where some STAs may not be under coverage of the AP, but can still connect through other devices operating as relay nodes.

The narrowband mesh networking system may provide an architecture where multiple narrowband channels can be used to form a multi-channel mesh network. Previous mesh networking solutions define mesh routing protocols on top of an existing protocol but do not address the problem of enabling mesh operation in a narrowband Wi-Fi architecture as proposed. Furthermore, mesh protocols are not optimized for resource constrained and low power devices, and do not enable multi-channel time synchronized mesh operation within a flexible narrowband Wi-Fi network architecture.

In one embodiment, a narrowband mesh networking system may facilitate dynamic allocation of the one or more narrowband data channels. For example, in one embodiment, the channels may vary in size based on one or more network requirements. Further, one or more of the narrowband data channels may be allocated for specific type of traffic.

In one embodiment, a narrowband mesh networking system may facilitate varying the size of the narrowband data channels by aggregating one or more narrowband data channels in order to meet bandwidth requirements. That is, in a narrowband mesh networking system, the one or more narrowband data channels are not statically defined. It is understood that the above descriptions are for purposes of illustration and are not meant to be limiting.

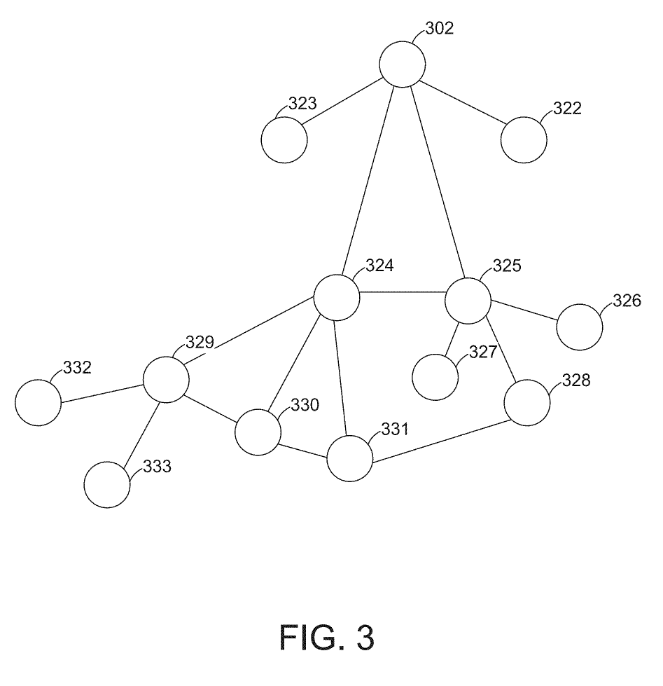

FIG. 3 depicts an illustrative mesh network, in accordance with one or more example embodiments of the present disclosure.

Referring to FIG. 3, there is shown a coordinator device 302 that is connected to one or more devices in order to form a mesh network. Some of these devices may act as relay devices in order to relay messages back and forth between the coordinator device 302 and devices that are outside the coverage area of the coordinator device 302. The relay devices may also relay messages between any two or more devices that need to communicate in the network. For example, the coverage area of the coordinator device 302 may include devices 322, 324, and 325. However, devices 326, 327, 328, 329, 330, 331, 332, and 333 may be outside the coverage area of the coordinator device 302. A narrowband mesh networking system may enable the devices within the coverage area of the coordinator device 302 (e.g., devices 322, 324 and 325) to act as relay devices between devices 326, 327, 328, 329, 330, 331, 332, 333 and the coordinator device 302.

For example, if device 329 needs to communicate with device 330, the device 324 may act as a relay device to assist the devices 329 and 330 to reach the coordinator device 302. The coordinator device 302 may utilize one of the control channels to communicate control traffic to the device 324, which in turn may communicate the control traffic to the devices 329 and 330. The coordinator device 302 may allocate one or more narrowband channels for data traffic. However, if user devices 329 and 330 cannot detect the control traffic sent from the coordinator device 302 they would not be able to transmit their data traffic or may have poor link quality with the coordinator device 302. Therefore, the device 324 may relay the control traffic, which includes any resource allocations to the devices 329 and 330 such that they are capable of transmitting their data traffic. It should be understood that the coordinator device 302 may be another device that is selected to operate as not work coordinator, which is within coverage of an AP. In other examples, the coordinator device may be the AP. It should understood that when a device is outside the coverage area may also cover cases when a device (e.g., devices 329 or 330) may communicate with the coordinator device 302 but at a lower rate or with a lower performance (e.g. higher packet error rate). For example, if power measurement or link quality falls below a threshold, a device may not reliably communicate with the coordinator device 302. In those cases, the user device 324 acting as a relay device may allow the device (e.g., devices 329 or 330) to have a more enhanced communication with the coordinator device 302. Hence, there is value in using the relay device even in cases where a certain device is within coverage of the coordinator device, but may have poor link quality. It is understood that the above descriptions are for purposes of illustration and are not meant to be limiting.

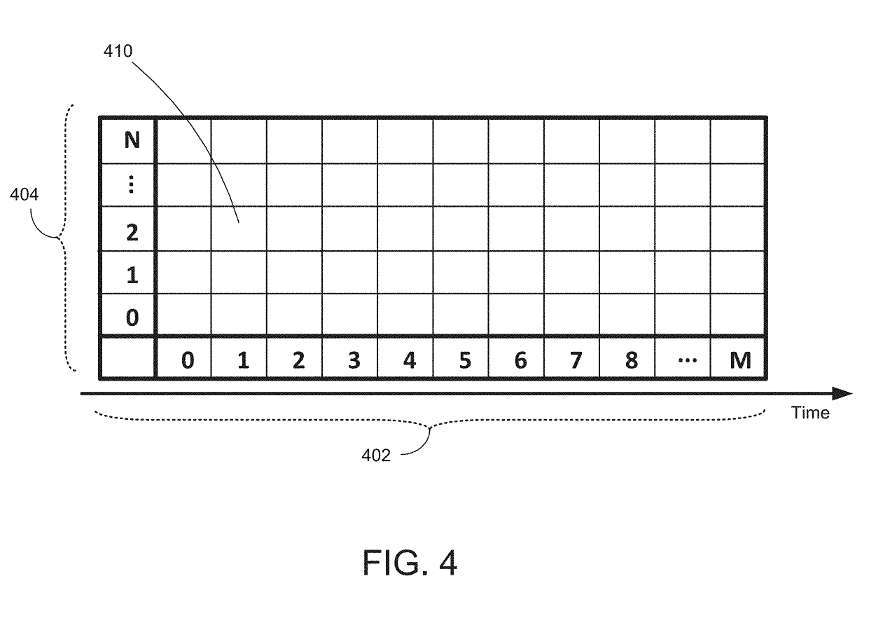

FIG. 4 depicts an illustrative narrowband service channel timeslot frame (TSF) structure, in accordance with one or more example embodiments of the present disclosure.

Referring to FIG. 4, there is shown a TSF structure that may be comprised of a two-dimensional array having timeslots on the time axis and narrowband channels (e.g., NBSCH) on the channels axis. For example, there may be timeslots 402, including timeslots 1, . . . , M, on the time axis, where M is an integer and there may be narrowband channels 404, including channels 1, . . . , N, on the channels axis, where N is an integer.

In one embodiment, a narrowband mesh networking system may facilitate a coordinator device to allocate a timeslot structure to maintain one or more timeslot allocations associated with the one or more narrowband channels. The number of narrowband channels within a frequency band may be determined based on the narrowband devices. For example, if the requirement is to have a 2 MHz narrowband, in a 20 MHz frequency band, then the number of narrowband data channels may be nine. However, if the requirement is to have smaller than 2 MHz narrowband, in the 20 MHz frequency band, then the number of narrowband data channels may increase. If the requirement is to have larger than 2 MHz band or if two or more narrowband data channels are aggregated together, then the number of narrowband data channels may decrease. The same is true depending on the frequency band. For example, in a 40 MHz frequency band, there may be a larger number of narrowband data channels. The allocation of the narrowband channels may also be dynamically updated during the network operation, which is not possible with existing technologies.

Initially, a device may need to be preconfigured in order to determine which devices are in proximity of the device. That is, the device may scan a pre-configured number of channels in order to find an AP or other neighboring devices. If the device could not find an AP typically, the device may not be able to access the network (e.g., the Internet). Either the device may have to be moved to be closer to an AP or additional APs may have to be added such that the device is able to access the network through an AP within its proximity.

In one embodiment, a narrowband mesh networking system may facilitate a relay device to relay information to devices that may be outside the range of an AP or may have a poor link quality with the AP. The information may include the narrowband channel allocations, including the narrowband data channels and narrowband control channels.

In one embodiment, a narrowband mesh networking may facilitate the allocation of one or more control channels that may be used by the AP and relay devices. For example, the AP may allocate channel 9 to be a control channel associated with traffic coming from the AP to the devices within the range of the AP. Further, the AP may allocate channel 7 to be control channel associated with relaying control traffic by a relay device.

In one embodiment, an AP or an STA may operate as a coordinator device and may define a set of NBSCHs available to be used in a time synchronized mode for a given duration. The coordinator device starts the operation in multi-channel time synchronized mode by defining and advertising a time slot frame (TSF), which consists of a set of transmission opportunity (TXOP) cells (e.g., TXOP cell 410). The TSF may be considered as a frame of timeslots. The coordinator device may encode the TSF in one or more frames for transmission to one or more devices that may be in the coverage area of the coordinator device. The coordinator device may utilize a trigger frame, a beacon frame, or any other management frame in order to advertise the TSF. The TSF may either be broadcast to all the devices within the range of the coordinator device. In other embodiments, the TSF may also be sent on the control channel (e.g., NBCCH). In another embodiment, the TSF may also be sent on one or more of the narrowband data channels (e.g., NBSCH). Each TXOP cell may be defined by a timeslot number and NBSCH number, as shown in FIG. 4. The TXOP cell may be the minimum resource unit that may be assigned to a given STA (or a link). A TSF may define a communication schedule for the network, which repeats periodically based on the TSF length. The schedule may be received by all devices that are within the range of the coordinator device. Each device will then determine, based on the TSF, which TXOP cell is assigned to it. In another embodiment, the schedule may be computed by each device locally based on a distributed protocol where devices negotiate and agree on timeslots and narrowband channels to communicate. It should be understood that the number of timeslots may vary based on the network requirements, the frequency at which the schedule in the TSF repeats, or the number of devices requiring access to the narrowband data channels.

In one embodiment, the TSF length may be at least the minimal duration for which the advertised set of NBSCHs are available and under the control of the coordinator device. The timeslot duration may be configurable, but it should be at least enough for one successful data frame exchange including acknowledgment, (e.g., DATA+ACK). Specific duration may be configured based on the application requirements.

As shown in FIG. 4, multiple transmissions are possible in different NBSCHs in a given timeslot. For example, multiple transmissions may occur on during timeslot 1 on different NBSCH numbers. It is understood that the above descriptions are for purposes of illustration and are not meant to be limiting.

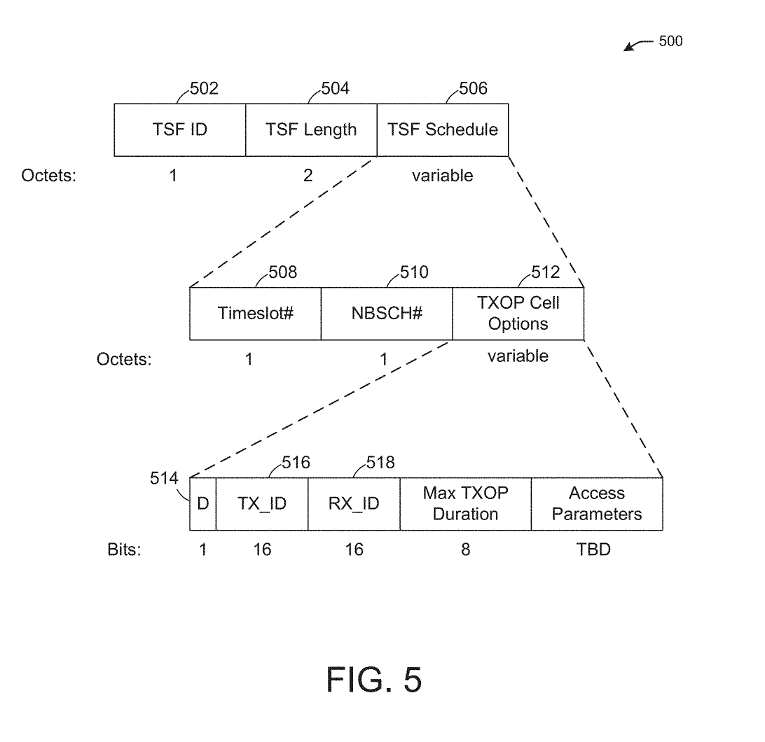

FIG. 5 depicts a narrowband service channel TSF, in accordance with one or more example embodiments of the present disclosure.

In one embodiment, a narrowband mesh networking system may facilitate the definition of one or more parameters associated with a TSF that may include one or more timeslot allocations for one or more narrowband channels. For example, a coordinator device may determine a TSF information element 500 that may include one or more TSF parameters. The TSF information element 500 may include a TSF ID 502, which is a logical identifier of the TSF because multiple TSFs may be created in the same network. The TSF information element 500 may also include a TSF length 504 that may define the number of timeslots in the TSF. The TSF information element 500 may also include a TSF schedule 506, which may provide the allocation of the TXOP cells and parameters that control the access to the channel within the TXOP cells.

In one embodiment, the narrowband mesh networking system may define the TSF schedule 506 to insist of a sequence of schedule elements as shown in FIG. 5. Each TSF schedule 506 may include a timeslot number 508, a NBSCH number 510 and a TXOP cell options information element 512, which defines a set of parameters associated to a given cell in the schedule.

The TXOP Cell Options Information Element 512 may include a D field 514, which may indicate whether the cell is dedicated (e.g. D=1) or shared (e.g. D=0). For dedicated cells, the TX_ID field 516 and RX_ID field 518 may indicate the addresses of the STA(s) that are allowed to transmit and receive, respectively. For shared cells, the TX_ID field 516 may be set to a broadcast address. Group communication can also be supported by configuring the TX and RX addresses in the cell allocation.

In one embodiment, a narrowband mesh networking system may define multiple TSFs in the same network. However, all TSFs may be synchronized to the same timeslot boundary. For instance, a coordinator device may define different TSFs for different types of application traffic (e.g. upstream, downstream, delay tolerant, delay sensitive, etc.). In one embodiment, different NBSCHs may be used in multiple TSFs in the same network. The coordinator device may control the overall time synchronization of the timeslots.

In one embodiment, and as discussed above, the coordinator device may be responsible for defining and advertising the TSF parameters in the NBCCH. In one embodiment, the TSF configuration (e.g. TSF information element 500) may be transmitted as part of a narrowband trigger frame (NBTF). In another embodiment, the TSF configuration parameters may be transmitted as a standalone control/management frame. The coordinator device may also provide time synchronization for all STAs in the network.

In another embodiment, multiple NBSCHs may be dedicated for low power mesh network applications using a dedicated TSF schedule. With this consideration, the TSF may be signaled in NBTFs sent by the Coordinator in each of these dedicated NBSCHs. Any other control/control response frames may also be used for TSF signaling. STAs operating as relay devices may re-transmit the TSF configuration as well as time synchronization information in order to enable STAs out of AP coverage to also connect to the network. In order to join the mesh network, STAs may detect the TSF configuration and synchronize from the AP/coordinator device or from other STAs operating as relay devices.

In one embodiment, a narrowband mesh networking system may schedule one or more transmissions for one or more devices during a TXOP cell. For example, during a given TXOP cell, and STA may be either in transmit, receive, or power save mode. The scheduling of TXOP cells to specific STAs may be done in a centralized or distributed approach.

In one embodiment, a centrally defined schedule (e.g. TSF Schedule 506 defined above) may be distributed by the coordinator device in the NBCCH as part of a narrowband trigger frame and re-transmitted by the STAs operating as relay devices. Periodic assignment of timeslots to an STA or groups of STAs (based on their sleep schedule) may be possible in order to reduce overhead (by not sending the TSF frequently).

In one embodiment, a narrowband mesh networking system may schedule a TXOP cell as a dedicated cell or a shared cell. A dedicated cell refers to a cell where only a single STA is allowed to transmit. A shared cell refers to a cell where multiple STAs may contend for transmission. In dedicated cells, STAs may transmit after a given guard time, meaning no contention. In shared cells, STAs may perform clear channel assessment (CCA) on the assigned NBSCH and invoke the backoff procedure, similar to the enhanced distributed channel access (EDCA) access rules for channel contention. Some of the unassigned TXOP cells in the TSF may be used by STAs not scheduled by the coordinator device but has some random bursty UL traffic to be transmitted to the relay device and finally to the coordinator device. It is understood that the above descriptions are for purposes of illustration and are not meant to be limiting.

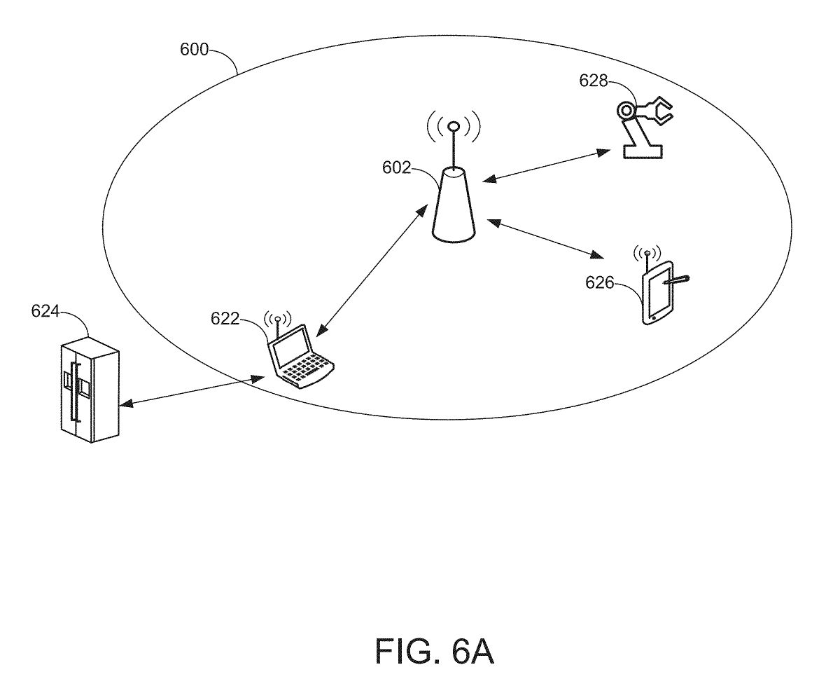

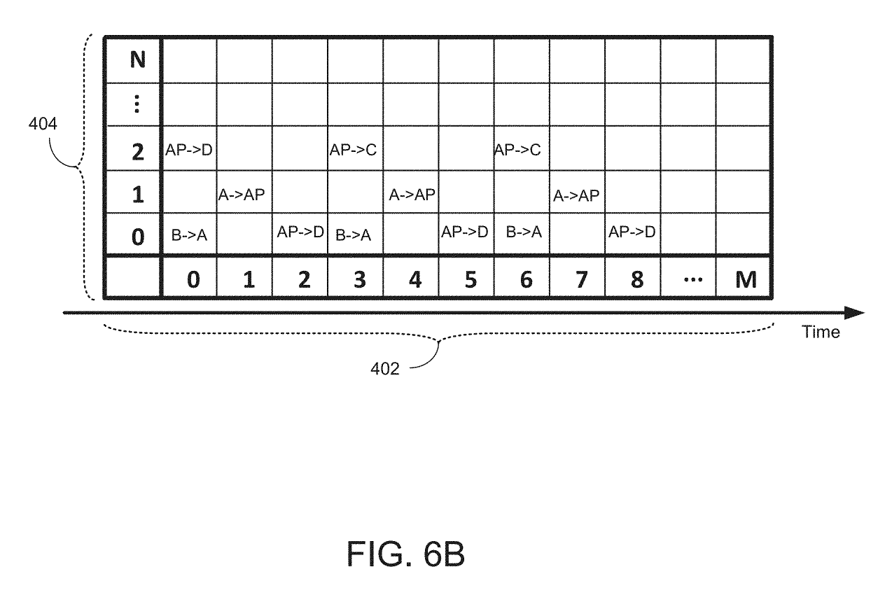

FIG. 6A depicts an illustrative narrowband mesh networking system, in accordance with one or more example embodiments of the present disclosure.

Referring to FIG. 6A, there is shown a mesh network of one or more IoT devices having an AP 602 with a coverage area 600. Within the coverage area 600, the AP 602 may be able to reach STA A 622, STA C 628, and STA D 626. However, STA B 624 may be outside the coverage area 600. This example illustrates an Industrial IoT scenario where sensors, actuators, and mobile STAs connect to a Wi-Fi based mesh network. In this example, since STA B 624 is outside of the coverage area 600 of the AP 602, it may connect through STA A 622, which operates as a relay device. It is understood that the above descriptions are for purposes of illustration and are not meant to be limiting.

FIG. 6B depicts an illustrative example of a narrowband service channel TSF, in accordance with one or more example embodiments of the present disclosure.

Continuing with the example of FIG. 6A, and referring to FIG. 6B, an example schedule within a TSF in which multiple narrowband transmissions are allocated to different STAs (e.g., STA A 622, STA B 624, STA C 628, and STA D 626). As can be seen, multi-hop communication between STA B 624 and the AP 602 is supported by allocating multiple TXOP cells between STA B 624 and STA A 622, and the AP 602. Furthermore, simultaneous transmissions may also be allocated, for instance, STA B->STA A and AP->STA D can both communicate in time slot 0. However, proper care must be taken in the scheduling decisions to avoid interference due to simultaneous transmissions. In order to support mesh operation, the devices that act as relay devices (e.g., STA A 622) may forward the TSF to devices (e.g., STA B 624) that are outside the range of the coordinator device (e.g., AP 602) in order to notify these devices of the scheduled allocations and timeslots. When the devices that are outside the range of the coordinator device receive the TSF from the relay device, the devices will decode the TSF in order to determine which TXOP cell is assigned for its data transmissions. It should be understood that in certain IoT applications, the traffic pattern may be predictable. As such, devices may go into a sleep mode and wakeup mode based on that predictable pattern. It is understood that the above descriptions are for purposes of illustration and are not meant to be limiting.

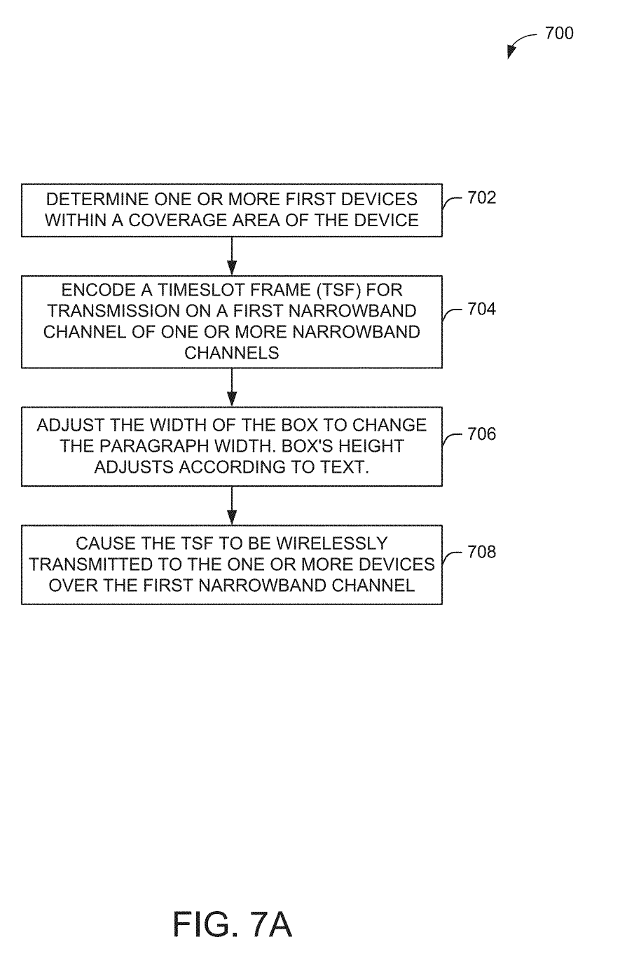

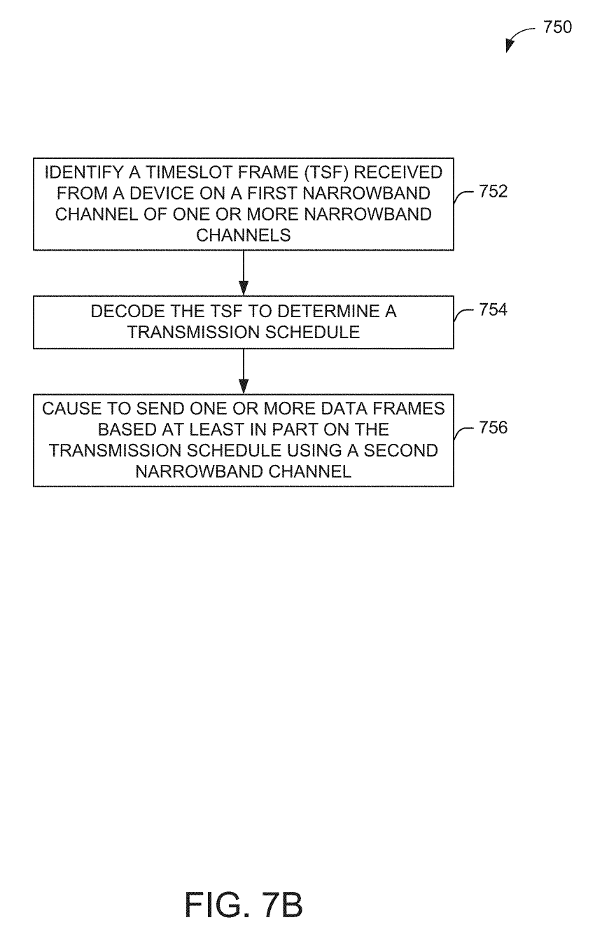

FIG. 7A illustrates a flow diagram of illustrative process 700 for an illustrative narrowband mesh networking system, in accordance with one or more example embodiments of the present disclosure.

At block 702, a device (e.g., the user device(s) 120 and/or the AP 102 of FIG. 1) may determine one or more first devices within a coverage area of the device. For example, a mesh network of one or more devices (e.g., IoT devices) having an AP 102 with a coverage area. Within the coverage area, the AP may be able to discover and reach some of these devices. However, some devices may be outside the coverage area of the AP 102.

At block 704, the device may encode a timeslot frame (TSF) for transmission on a first narrowband channel of one or more narrowband channels. For example, a coordinator device (e.g., the AP 102) may encode the TSF in one or more frames for transmission to one or more devices that may be in the coverage area of the coordinator device. The AP 102 may utilize a trigger frame, a beacon frame, or any other management frame in order to advertise the TSF.

The one or more narrowband channels are associated with a wideband frequency. For example, the wideband frequency channel may be divided into multiple narrowband subchannels that may be dedicated for certain functions. For example, a wideband frequency channel may be divided into a number narrowband channels (e.g., 9 narrowband channels, or any other number). The narrowband channels may be dedicated channels. For example narrowband channels may be comprised of one or more narrowband service channels (NBSCH) and/or one or more narrowband control channels (NBCCH).

At block 706, the device may cause the TSF to be wirelessly transmitted to the one or more devices over the first narrowband channel. The TSF may either be broadcast to all the devices within the coverage area of the coordinator device. The TSF may also be sent on a control channel (e.g., NBCCH). In another embodiment, the TSF may also be sent on one or more of the narrowband data channels (e.g., NBSCH). Each TXOP cell may be defined by a timeslot number and NBSCH number, as shown in FIG. 4. The TXOP cell may be the minimum resource unit that may be assigned to a given a device (or a link). A TSF may define a communication schedule for the network, which repeats periodically based on the TSF length. The schedule may be received by all devices that are within the range of the coordinator device. Each device will then determine, based on the TSF, which TXOP cell is assigned to it. It is understood that the above descriptions are for purposes of illustration and are not meant to be limiting.

FIG. 7B illustrates a flow diagram of illustrative process 750 for an illustrative narrowband mesh networking system, in accordance with one or more example embodiments of the present disclosure.

At block 752, a device (e.g., the user device(s) 120 and/or the AP 102 of FIG. 1) may identify a timeslot frame (TSF) received from a device on a first narrowband channel of one or more narrowband channels. For example, in a mesh network, a coordinator device (e.g., the AP 102) may be in communication with one or more devices (e.g., IoT devices). The coordinator device may have a certain coverage area. Within the coverage area, the coordinator device may be able to discover and reach some of these devices. However, some devices may be outside the coverage area of the coordinator device. The coordinator device may encode the TSF in one or more frames for transmission to one or more devices that may be in the coverage area of the coordinator device. The coordinator may utilize a trigger frame, a beacon frame, or any other management frame in order to advertise the TSF. This TSF may be received by devices that are within the coverage area of the coordinator device and may be transmitted or forwarded to devices that are outside the coverage area of the coordinator device. In that case, the device that forwards the TSF to devices outside the coverage area may be considered as relay devices.

At block 754, the device may decode the TSF to determine a transmission schedule. When a device receives the trigger frame, beacon frame or any other management frame including the TSF, the device would decode the TSF in order to determine its resource allocation in the form of a TXOP cell that indicates the time and the narrowband channel assigned to that device. In another embodiment, the device may use a generic schedule information (e.g. which timeslots and narrowband channels are available) to determine its own communication schedule with its neighbors (or parent/relay device). Hence, the determination of the schedule may be done in various ways, but it is based on the information received in the TSF information element.

At block 756, the device may cause to send one or more data frames based at least in part on the transmission schedule using a second narrowband channel. Using the resource allocation of time and narrowband channel, a device may be able to communicate or otherwise send its data based on that allocation. It is understood that the above descriptions are for purposes of illustration and are not meant to be limiting.

FIG. 8 shows a functional diagram of an exemplary communication station 800 in accordance with some embodiments. In one embodiment, FIG. 8 illustrates a functional block diagram of a communication station that may be suitable for use as an AP 102 (FIG. 1) or a user device 120 (FIG. 1) in accordance with some embodiments. The communication station 800 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 800 may include communications circuitry 802 and a transceiver 810 for transmitting and receiving signals to and from other communication stations using one or more antennas 801. The communications circuitry 802 may include circuitry that can operate the physical layer (PHY) communications and/or media access control (MAC) communications for controlling access to the wireless medium, and/or any other communications layers for transmitting and receiving signals. The communication station 800 may also include processing circuitry 806 and memory 808 arranged to perform the operations described herein. In some embodiments, the communications circuitry 802 and the processing circuitry 806 may be configured to perform operations detailed in FIGS. 1, 2, 3, 4, 5, 6A, 6B, 7A, and 7B.

In accordance with some embodiments, the communications circuitry 802 may be arranged to contend for a wireless medium and configure frames or packets for communicating over the wireless medium. The communications circuitry 802 may be arranged to transmit and receive signals. The communications circuitry 802 may also include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the communications circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device memory.

FIG. 9 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The machine 900 may additionally include a storage device (i.e., drive unit) 916, a signal generation device 918 (e.g., a speaker), a narrowband mesh networking device 919, a network interface device/transceiver 920 coupled to antenna(s) 930, and one or more sensors 928, such as a global positioning system (GPS) sensor, a compass, an accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

The narrowband mesh networking device 919 may carry out or perform any of the operations and processes (e.g., processes 700 and 750) described and shown above. For example, the narrowband mesh networking device 919 may be configured to enable a more flexible and scalable mesh operation, which is required for supporting many IoT applications and systems.

The narrowband mesh networking device 919 may enable the usage of narrowband Wi-Fi sub-channels within a single wide band channel in a mesh topology in a time synchronized fashion, which allows for low power operation and better coexistence with typical Wi-Fi traffic.

The narrowband mesh networking device 919 may enable an AP to act as a coordinator device that may define a time slot frame structure, may provide time synchronization, and may acquire and/or announce available resources across multiple narrowband sub-channels and time slots to one or more devices within the coverage area of the AP.

The narrowband mesh networking device 919 may enable a more flexible and scalable operation between one or more devices, which is required for supporting many IoT applications and systems. IoT devices may require optimized power usage and may not meet a large bandwidth for their communications.

It is understood that the above are only a subset of what the narrowband mesh networking device 919 may be configured to perform and that other functions included throughout this disclosure may also be performed by the narrowband mesh networking device 919.

While the machine-readable medium 922 is illustrated as a single medium, the term “machine-readable medium” may include a single medium or multiple media (e.g., a centralized or distributed database, and/or associated caches and servers) configured to store the one or more instructions 924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include memory and processing circuitry configured to determine one or more first devices within a coverage area of the device. The memory and processing circuitry may be further configured to encode a timeslot frame (TSF) for transmission on a first narrowband channel of one or more narrowband channels. The memory and processing circuitry may be further configured to cause the TSF to be wirelessly transmitted to the one or more devices over the first narrowband channel.

The implementations may include one or more of the following features. The one or more narrowband channels are associated with a wideband frequency. The first narrowband channel is at least one of a narrowband data channel or a narrowband control channel. The memory and the processing circuitry are further configured to determine a first device of the one or more devices is a relay device, wherein the first device is in a proximity of a second device, the second device being outside the coverage area of the device. At least one narrowband control channel is used by the relay device to relay the TSF to the second device. The TSF may include at least in part a TSF schedule of one or more transmission opportunity (TXOP) cells. At least one of the one or more TXOP cells is a dedicated cell or a shared cell. The TSF may include a TXOP bit field to indicate whether a TXOP cell of the one or more TXOP cells is a dedicated cell or a shared cell. The one or more narrowband channels are variable in size based at least in part on the wideband frequency. The device may further include a transceiver configured to transmit and receive wireless signals. The device may further include one or more antennas coupled to the transceiver.

According to example embodiments of the disclosure, there may be a device. The device may include memory and processing circuitry configured to identify a timeslot frame (TSF) received from a device on a first narrowband channel of one or more narrowband channels. The memory and processing circuitry may be further configured to decode the TSF to determine a transmission schedule. The memory and processing circuitry may be further configured to cause to send one or more data frames based at least in part on the transmission schedule using a second narrowband channel.

The implementations may include one or more of the following features. The device is a coordinator device or a relay device. The one or more narrowband channels are associated with a wideband frequency. The TSF may include at least in part a TSF schedule of one or more transmission opportunity (TXOP) cells. At least one of the one or more TXOP cells is a dedicated cell or a shared cell. The first narrowband channel is a narrowband control channel and the second narrowband channel is a narrowband data channel.

According to example embodiments of the disclosure, there may be a non-transitory computer-readable medium storing computer-executable instructions which, when executed by a processor, cause the processor to perform operations. The operations may include determining, by one or more processors, one or more first devices within a coverage area of the device. The operations may include encoding a timeslot frame (TSF) for transmission on a first narrowband channel of one or more narrowband channels. The operations may include causing the TSF to be wirelessly transmitted to the one or more devices over the first narrowband channel.

The implementations may include one or more of the following features. The one or more narrowband channels are associated with a wideband frequency. The first narrowband channel is at least one of a data channel or a control channel. The non-transitory computer-readable medium of claim 30, wherein they operations further comprise determining a first device of the one or more devices is a relay device, wherein the first device is in a proximity of a second device, the second device being outside the coverage area of the device. At least one narrowband control channel is used by the relay device to relay the TSF to the second device. The TSF may include at least in part a TSF schedule of one or more transmission opportunity (TXOP) cells. At least one of the one or more TXOP cells is a dedicated cell or a shared cell. The TSF may include a TXOP bit field to indicate whether a TXOP cell of the one or more TXOP cells is a dedicated cell or a shared cell. The one or more narrowband channels are variable in size based at least in part on the wideband frequency.

According to example embodiments of the disclosure, there may be a non-transitory computer-readable medium storing computer-executable instructions which, when executed by a processor, cause the processor to perform operations. The operations may include identifying a timeslot frame (TSF) received from a device on a first narrowband channel of one or more narrowband channels. The operations may include decoding the TSF to determine a transmission schedule. The operations may include causing to send one or more data frames based at least in part on the transmission schedule using a second narrowband channel. The implementations may include one or more of the following features. The device may be a coordinator device or a relay device. The one or more narrowband channels may be associated with a wideband frequency. The TSF may include at least in part a TSF schedule of one or more transmission opportunity (TXOP) cells. At least one of the one or more TXOP cells may be a dedicated cell or a shared cell. The first narrowband channel may be a narrowband control channel and the second narrowband channel is a narrowband data channel.

According to example embodiments of the disclosure, there may include a method. The method may include determining, by one or more processors, one or more first devices within a coverage area of the device. The method may include encoding a timeslot frame (TSF) for transmission on a first narrowband channel of one or more narrowband channels. The method may include causing the TSF to be wirelessly transmitted to the one or more devices over the first narrowband channel.

The implementations may include one or more of the following features. The one or more narrowband channels are associated with a wideband frequency. The first narrowband channel is at least one of a data channel or a control channel. The method may further include determining a first device of the one or more devices is a relay device, wherein the first device is in a proximity of a second device, the second device being outside the coverage area of the device. At least one narrowband control channel is used by the relay device to relay the TSF to the second device. The TSF includes at least in part a TSF schedule of one or more transmission opportunity (TXOP) cells. At least one of the one or more TXOP cells is a dedicated cell or a shared cell. The TSF includes a TXOP bit field to indicate whether a TXOP cell of the one or more TXOP cells is a dedicated cell or a shared cell. The one or more narrowband channels are variable in size based at least in part on the wideband frequency.

According to example embodiments of the disclosure, there may include a method. The method may include identifying a timeslot frame (TSF) received from a device on a first narrowband channel of one or more narrowband channels. The method may include decoding the TSF to determine a transmission schedule. The method may include causing to send one or more data frames based at least in part on the transmission schedule using a second narrowband channel.

The implementations may include one or more of the following features. The device is a coordinator device or a relay device. The one or more narrowband channels are associated with a wideband frequency. The TSF includes at least in part a TSF schedule of one or more transmission opportunity (TXOP) cells. At least one of the one or more TXOP cells is a dedicated cell or a shared cell. The first narrowband channel is a narrowband control channel and the second narrowband channel is a narrowband data channel.

In example embodiments of the disclosure, there may be an apparatus. The apparatus may include means for determining, by one or more processors, one or more first devices within a coverage area of the device. The apparatus may include. The apparatus may include means for encoding a timeslot frame (TSF) for transmission on a first narrowband channel of one or more narrowband channels. The apparatus may include. The apparatus may include means for causing the TSF to be wirelessly transmitted to the one or more devices over the first narrowband channel.

The implementations may include one or more of the following features. The one or more narrowband channels are associated with a wideband frequency. The first narrowband channel is at least one of a data channel or a control channel. The apparatus may further include means for determining a first device of the one or more devices is a relay device, wherein the first device is in a proximity of a second device, the second device being outside the coverage area of the device. At least one narrowband control channel is used by the relay device to relay the TSF to the second device. The TSF includes at least in part a TSF schedule of one or more transmission opportunity (TXOP) cells. At least one of the one or more TXOP cells is a dedicated cell or a shared cell. The TSF includes a TXOP bit field to indicate whether a TXOP cell of the one or more TXOP cells is a dedicated cell or a shared cell. The one or more narrowband channels are variable in size based at least in part on the wideband frequency.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1. A device, the device comprising memory and processing circuitry configured to:
determine one or more first devices within a coverage area of the device;
encode a timeslot frame (TSF) for transmission on a first narrowband channel of one or more narrowband channels; and
cause the TSF to be wirelessly transmitted to the one or more devices over the first narrowband channel.

2. The device of claim 1, wherein the one or more narrowband channels are associated with a wideband frequency.

3. The device of claim 1, wherein the first narrowband channel is at least one of a narrowband data channel or a narrowband control channel.

4. The device of claim 1, wherein the memory and the processing circuitry are further configured to determine a first device of the one or more devices is a relay device, wherein the first device is in a proximity of a second device, the second device being outside the coverage area of the device or having a link performance below a threshold.

5. The device of claim 4, wherein at least one narrowband control channel is used by the relay device to relay the TSF to the second device.

6. The device of claim 4, wherein the TSF includes at least in part a TSF schedule of one or more transmission opportunity (TXOP) cells.

7. The device of claim 6, wherein at least one of the one or more TXOP cells is a dedicated cell or a shared cell.

8. The device of claim 7, wherein the TSF includes a TXOP bit field to indicate whether a TXOP cell of the one or more TXOP cells is a dedicated cell or a shared cell.

9. The device of claim 2, wherein the one or more narrowband channels are variable in size based at least in part on the wideband frequency.

10. The device of claim 1, further comprising a transceiver configured to transmit and receive wireless signals.

11. The device of claim 10, further comprising one or more antennas coupled to the transceiver.

12. A non-transitory computer-readable medium storing computer-executable instructions which when executed by one or more processors result in performing operations comprising:
identify a timeslot frame (TSF) received from a device on a first narrowband channel of one or more narrowband channels;
decode the TSF to determine a transmission schedule; and
cause to send one or more data frames based at least in part on the transmission schedule using a second narrowband channel.

13. The non-transitory computer-readable medium of claim 12, wherein the device is a coordinator device or a relay device.

14. The non-transitory computer-readable medium of claim 12, wherein the one or more narrowband channels are associated with a wideband frequency.

15. The non-transitory computer-readable medium of claim 12, wherein the TSF includes at least in part a TSF schedule of one or more transmission opportunity (TXOP) cells.

16. The non-transitory computer-readable medium of claim 15, wherein at least one of the one or more TXOP cells is a dedicated cell or a shared cell.

17. The non-transitory computer-readable medium of claim 12, wherein the first narrowband channel is a narrowband control channel and the second narrowband channel is a narrowband data channel.

18. A method comprising:
determining, by one or more processors, one or more first devices within a coverage area of the device;
encoding a timeslot frame (TSF) for transmission on a first narrowband channel of one or more narrowband channels; and
causing the TSF to be wirelessly transmitted to the one or more devices over the first narrowband channel.

19. The method of claim 18, wherein the one or more narrowband channels are associated with a wideband frequency.

20. The method of claim 18, wherein the first narrowband channel is at least one of a data channel or a control channel.
